(19) United States
(12) Patent Application Publication
(10) Pub. No.: US 2015/0249810 A1
(43) Pub. Date: Sep. 3, 2015

(54) IMAGE PROCESSING APPARATUS AND METHOD, IMAGE PROCESSING SYSTEM, AND NON-TRANSITORY COMPUTER READABLE MEDIUM

(71) Applicant: FUJI XEROX CO., LTD., Tokyo (JP)

(72) Inventor: Makoto SASAKI, Kanagawa (JP)

(73) Assignee: FUJI XEROX CO., LTD., Tokyo (JP)

(21) Appl. No.: 14/472,891

(22) Filed: Aug. 29, 2014

(30) Foreign Application Priority Data
Feb. 28, 2014 (JP) 2014-039869

(51) Int. Cl. H04N 9/64; G06T 5/00; G06T 11/40

(52) U.S. Cl. CPC H04N 9/643; G06T 11/40; G06T 5/004; G06T 5/008; G06T 2207/10024; G06T 2207/10004

(57) ABSTRACT

An image processing apparatus includes the following elements. A specified region detector detects, from an image to be subjected to image processing, a specified region selected by a user as an image region to be subjected to image processing. A hue replacement unit replaces image information concerning the specified region so that hue values represented by the image information will become substantially uniform if the specified region is an image exhibiting saturation lower than a predetermined saturation. The image processor performs image processing on the specified region on the basis of the image information replaced by the hue replacement unit.

### CROSS-REFERENCE TO RELATED APPLICATIONS

This application is based on and claims priority under 35 USC 119 from Japanese Patent Application No. 2014-039869 filed Feb. 28, 2014.

### BACKGROUND

### Technical Field

The present invention relates to an image processing apparatus and method, an image processing system, and a non-transitory computer readable medium.

### SUMMARY

According to an aspect of the invention, there is provided an image processing apparatus including the following elements. A specified region detector detects, from an image to be subjected to image processing, a specified region selected by a user as an image region to be subjected to image processing. A hue replacement unit replaces image information concerning the specified region so that hue values represented by the image information will become substantially uniform if the specified region is an image exhibiting saturation lower than a predetermined saturation. The image processor performs image processing on the specified region on a basis of the image information replaced by the hue replacement unit.

### BRIEF DESCRIPTION OF THE DRAWINGS

Exemplary embodiments of the present invention will be described in detail based on the following figures, wherein:

FIG. 1 illustrates an example of the configuration of an image processing system according to an exemplary embodiment of the invention;

FIG. 2 is a block diagram illustrating an example of the functional configuration of an image processing apparatus according to a first exemplary embodiment of the invention;

FIG. 3 illustrates that chroma is defined by the Euclidean distance from an origin in an a*b* plane;

FIG. 4 illustrates a first example of an approach to selecting a specified region user-interactively;

FIG. 5A illustrates the max-flow min-cut theorem;

FIG. 5B illustrates a specific example in which an image is segmented into two regions when two seeds are provided;

FIGS. 6A through 6C illustrate a specified region which is cut from an image shown in FIG. 4;

FIGS. 7A and 7B illustrate processing for blurring a boundary between a specified region and an unspecified region;

FIGS. 8A and 8B illustrate a second example of an approach to selecting a specified region user-interactively;

FIGS. 9A and 9B illustrate the distribution of hue values when an image is a low saturation image having a color close to gray;

FIGS. 10A and 10B illustrate the replacement of hue values by using expressions (5);

FIGS. 11A and 11B illustrate the replacement of hue values so that they will approximate to an average hue value;

FIG. 12A illustrates the distribution of hue values in an H-S plane which have not been replaced;

FIG. 12B illustrates the distribution of hue values in the H-S plane which have been replaced by using a technique discussed in FIGS. 10A and 10B or FIGS. 11A and 11B;

FIG. 13 illustrates the distribution of pixel values as a result of enhancing saturation on the basis of replaced image information obtained by replacing hue values;

FIG. 14A illustrates an example of an image obtained as a result of enhancing saturation without making the hue values of a skirt portion, which is set as a specified region, uniform;

FIG. 14B illustrates an example of an image obtained as a result of enhancing saturation after making the hue values of a skirt portion, which is set as a specified region, uniform;

FIG. 15A illustrates an example of a slider for adjusting the hue;

FIG. 15B illustrates an example of a tone curve used for adjusting the hue by using the slider shown in FIG. 15A when the hue values have been replaced so as to approximate to an average hue value;

FIG. 16A illustrates an example of a slider for adjusting the saturation;

FIG. 16B illustrates an example of a tone curve used for adjusting the saturation by using the slider shown in FIG. 16A;

FIG. 17A illustrates an example of a slider for adjusting the value;

FIG. 17B illustrates an example of a tone curve used for adjusting the value by using the slider shown in FIG. 17A;

FIG. 18 illustrates an example of a frame displayed on a display screen when adjustment of the hue and the saturation is performed;

FIGS. 19A and 19B illustrate another example of frames displayed on a display screen when adjustment of the hue, the saturation, and the value is performed;

FIGS. 20A through 20C illustrate still another example of frames displayed on a display screen when adjustment of the hue, the saturation, and the value is performed;

FIG. 21 is a flowchart illustrating an operation performed by the image processing apparatus according to the first exemplary embodiment;

FIG. 22 is a block diagram illustrating an example of the functional configuration of an image processing apparatus according to a second exemplary embodiment;

FIG. 23 illustrates an example of a saturation adaptive function;

FIG. 24A illustrates the distribution of hue values in the H-S plane when a specified region includes a gradation;

FIG. 24B illustrates the distribution of hue values as a result of replacing the hue values by using a saturation adaptive function;

FIG. 25 is a flowchart illustrating an operation performed by the image processing apparatus according to the second exemplary embodiment; and

FIG. 26 illustrates an example of the hardware configuration of the image processing apparatus.

### DETAILED DESCRIPTION

Exemplary embodiments of the invention will be described below in detail with reference to the accompanying drawings.

In regard to the execution of image adjustment, such as hue adjustment, on color images, there are various techniques to perform image adjustment particularly for non-artificial pictures. Generally, if color adjustment is performed according to the element, such as the hue, saturation, and value (lightness), a resulting image appears to match human perception. These days, some commercial software or free software applications provide a hue slider, a saturation slider, and a value slider, which allow a user to easily perform image adjustment.

When a user controls the hue or saturation by using a slider, the user usually adds an extra value to an original hue value or an original saturation value by sliding the slider. This may make a resulting image look unnatural and different from the image that the user has expected. The reason for this is due to a limitation on performing color adjustment by using a slider. To perform more complicated color adjustment, it is necessary to adjust the hue or saturation by considering characteristics of the hue or shade unique to a non-artificial image.

As an example of the complicated color adjustment performed by the related art, the following technique is available. Different saturation degrees are set for a high saturation portion and a low saturation portion of an image, and then, saturation adjustment is performed on each of the high saturation portion and the low saturation portion. There is also a technique for performing saturation adjustment on each of objects forming an image, assuming that a suitable saturation adjustment is different depending on the attribute of an object.

There is also another technique in which by using a modified graphical user interface (GUI), a hue indicator and a saturation indicator are displayed such that they circumscribe a cut object, so that a user is able to easily adjust the hue and saturation for each object within an image.

However, if the color of an image region to be subjected to image adjustment is a low saturation color close to gray, when image information is divided into elements, such as the hue, saturation, and value, hue values may be distributed almost over the entire region. In this case, if the saturation is increased, the saturation of this region is enhanced while maintaining various colors included in this region. As a result, an image subjected to image adjustment becomes nonuniform. Additionally, coloring is performed on a gray image region. This is, however, difficult to perform by the related art.

In an exemplary embodiment of the invention, an image processing system 1, which will be discussed below, is used in order to address the above-described issues.

### Description of Image Processing System

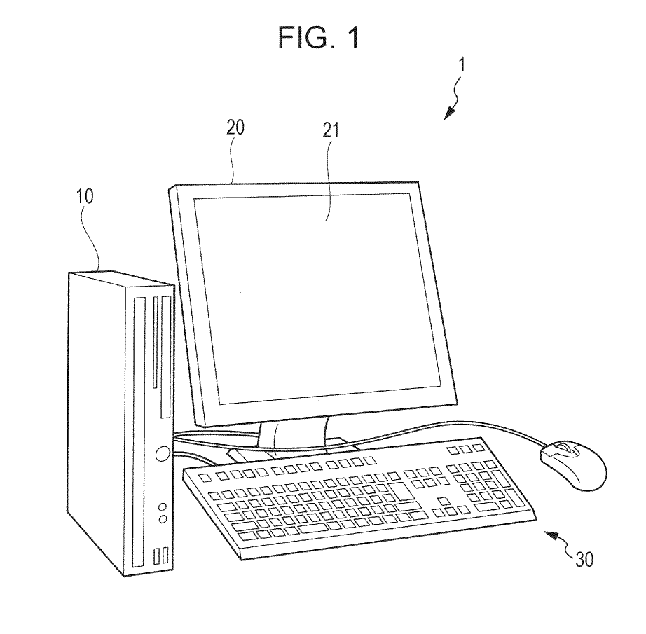

FIG. 1 illustrates an example of the configuration of the image processing system 1 of an exemplary embodiment.

The image processing system 1 includes, as shown in FIG. 1, an image processing apparatus 10, a display device 20, and an input device 30. The image processing apparatus 10 performs image processing on image information representing an image displayed on the display device 20. The display device 20 receives image information generated by the image processing apparatus 10 and displays an image on the basis of this image information. A user inputs various items of information into the image processing apparatus 10 by using the input device 30.

The image processing apparatus 10 is, for example, a so-called general-purpose personal computer (PC). The image processing apparatus 10 generates image information by operating various application software programs under the control of an operating system (OS).

The display device 20 displays an image on a display screen 21. The display device 20 is constituted by a device having a function of displaying an image by utilizing additive color mixing, such as a liquid crystal display for a PC, a liquid crystal display television, or a projector. Accordingly, the display method of the display device 20 is not restricted to a liquid crystal display method. In the example shown in FIG. 1, the display screen 21 is provided in the display device 20. However, if a projector, for example, is used as the display device 20, the display screen 21 is a screen provided outside the display device 20.

The input device 30 is constituted by a keyboard, a mouse, and so on. The input device 30 is used for starting or quitting application software for performing image processing. The input device 30 is also used by a user for inputting an instruction concerning image processing to be performed into the image processing apparatus 10, and such an operation will be discussed later in detail.

The image processing apparatus 10 and the display device 20 are connected to each other via a digital visual interface (DVI). Instead of DVI, a high-definition multimedia interface (HDMI) or DisplayPort may be used.

The image processing apparatus 10 and the input device 30 are connected to each other via, for example, a universal serial bus (USB). Instead of USB, IEEE1394 or RS-232C may be used.

In the image processing system 1, on the display device 20, an original image, which is an image that has not been subjected to image processing, is displayed. Then, when a user inputs an instruction concerning image processing to be performed into the image processing apparatus 10 by using the input device 30, the image processing apparatus 10 performs image processing on image information representing the original image. A result of performing image processing is reflected in the image displayed on the display device 20, so that an image subjected to image processing is redrawn and displayed on the display device 20. In this case, the user is able to perform image processing interactively while viewing the display device 20, thereby making it possible to proceed with an image processing operation more intuitively and more easily.

The image processing system 1 in an exemplary embodiment of the invention is not restricted to the configuration shown in FIG. 1. For example, a tablet terminal may be used as the image processing system 1. In this case, a tablet terminal includes a touch panel, and an image is displayed on this touch panel and a user inputs an instruction by using this touch panel. That is, the touch panel serves as the display device 20 and the input device 30. Similarly, a touch monitor may be used as a device integrating the display device 20 and the input device 30. In the touch monitor, a touch panel is used as the display screen 21 of the display device 20. In this case, the image processing apparatus 10 generates image information, and, on the basis of this image information, an image is displayed on the touch monitor. The user then inputs an instruction concerning image processing to be performed by touching the touch monitor.

### Description of Image Processing Apparatus

### First Exemplary Embodiment

A first exemplary embodiment of the image processing apparatus 10 will be described below.

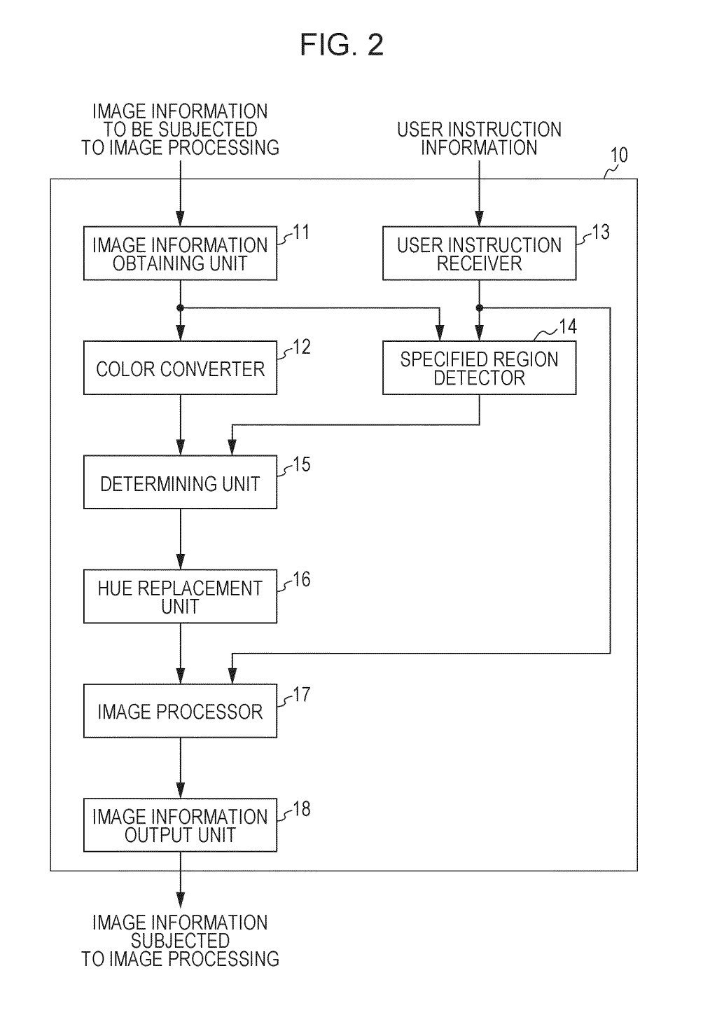

FIG. 2 is a block diagram illustrating an example of the functional configuration of the image processing apparatus 10 according to the first exemplary embodiment of the invention. Among various functions of the image processing apparatus 10, functions related to the first exemplary embodiment are selected and shown in FIG. 2.

The image processing apparatus 10 of the first exemplary embodiment includes, as shown in FIG. 2, an image information obtaining unit 11, a color converter 12, a user instruction receiver 13, a specified region detector 14, a determining unit 15, a hue replacement unit 16, an image processor 17, and an image information output unit 18.

The image information obtaining unit 11 obtains image information indicating an image to be subjected to image processing. That is, the image information obtaining unit 11 obtains image information that has not been subjected to image processing. This image information is, for example, red, green, and blue video data (RGB data) for displaying an image on the display device 20.

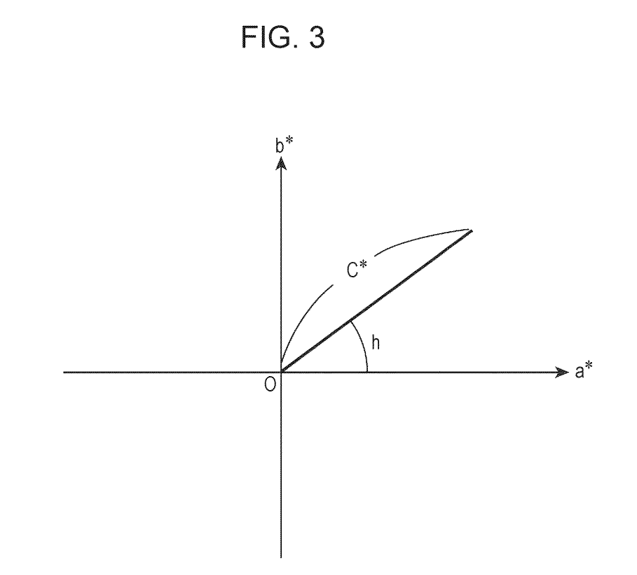

The color converter 12 converts RGB data into device-independent color data. In the first exemplary embodiment, the color converter 12 converts RGB data into, for example, HSV data represented by hue (H), saturation (S), and value (V). With this conversion, a user is able to perform image adjustment so that a resulting image will appear closer to human perception. However, color data is not restricted to HSV data, and any color data may be used as long as hue, saturation, and value (brightness) may be determined. For example, color data in a luminance-chrominance space, such as L*a*b* data representing L*a*b* values or YCbCr data representing Y, Cb, and Cr values, may be used. If the color data is represented by L*a*b* data, as shown in FIG. 3, chroma C* may be defined by the Euclidean distance from the origin O in the a*b* plane. That is, the chroma C* may be expressed by equation (1).

C*=\sqrt{a*²+b*²} (1)

Hue may be defined, as shown in FIG. 3, by an angle (hue angle h) from the a* axis in the a*b* plane.

The user instruction receiver 13 receives an instruction concerning image processing input by a user through the input device 30.

More specifically, the user instruction receiver 13 receives, as user instruction information, an instruction concerning an image region to be subjected to image processing selected by the user from an image displayed on the display device 20. The user instruction receiver 13 also receives, as user instruction information, an instruction concerning an element and an amount of image processing to be performed on this image region and determined by the user. A detailed description of the user instruction information will be given later.

The specified region detector 14 detects, from an image displayed on the display device 20, a region specified by a user as an image region to be subjected to image processing, on the basis of an instruction from the user received by the user instruction receiver 13. Specifically, the specified region detector 14 performs image segmentation to cut a specified region from the image displayed on the display device 20.

The technique for cutting a specified region is not particularly restricted. For example, there are two approaches to cutting a specified region: in one approach, the specified region is cut on the basis of a color; and in the other approach, the specified region is cut user-interactively.

In the color-based approach, the user specifies a color, and then, pixels having a color close to the specified color are extracted from an image including a specified region, thereby cutting the specified region. Alternatively, a mask weighted by the proximity to a specified color is prepared, and an image is extracted by using this mask, thereby cutting a specified region.

In the user interactive approach, the following method, for example, may be employed.

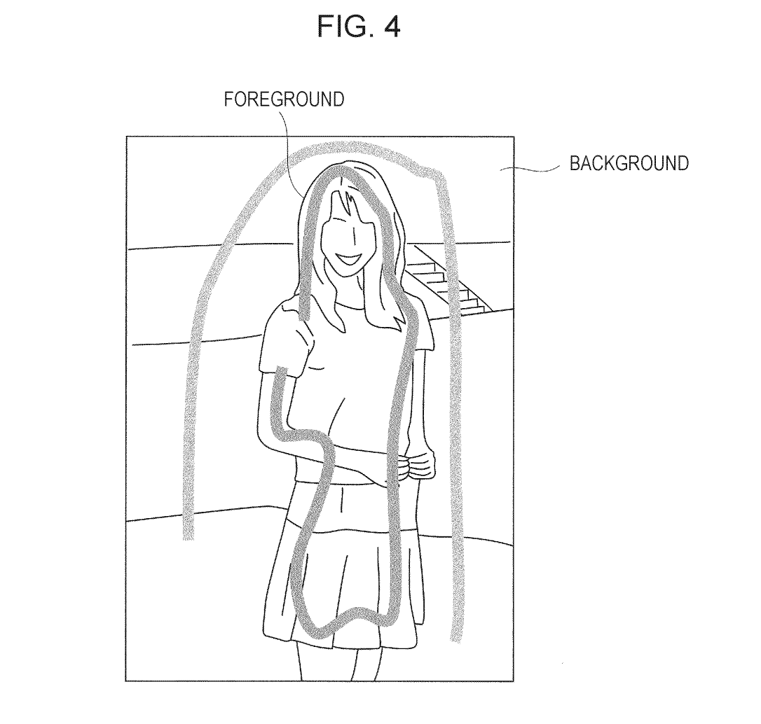

FIG. 4 illustrates a first example of the approach to selecting a specified region user-interactively.

In the example in FIG. 4, the image displayed on the display device 20 is a photo image constituted by a person shown as a foreground and a background shown behind the person, and a user selects the person as the foreground as a specified region.

In this case, the user provides a path of the foreground and a path of the background, as representatives of the foreground and the background, with a boundary between the two paths. The user may input these paths by using the input device 30. More specifically, if the input device 30 is a mouse, the user draws paths by operating the mouse to drag the image shown in FIG. 4 on the display device 20. If the input device 30 is a touch panel, the user draws paths by moving a finger or a touch pen on the display screen (swiping). Instead of paths, dots may be provided. That is, a representative of the foreground and a representative of the background may be indicated in any manner as long as information indicating positions thereof is provided. Hereinafter, information concerning, for example, a path representing a foreground (in this case, a specified region) may be referred to as a “foreground seed”, and information concerning, for example, a path representing a background (in this case, other than a specified region) may be referred to as a “background seed”.

In order to cut a specified region on the basis of the foreground seed and the background seed by the specified region detector 14, a technique for utilizing the max-flow min-cut theorem by assuming an image as a graph may be employed.

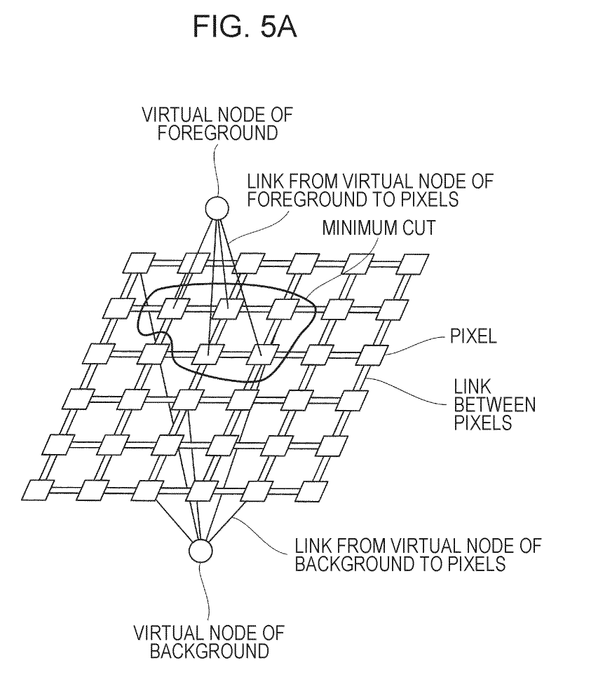

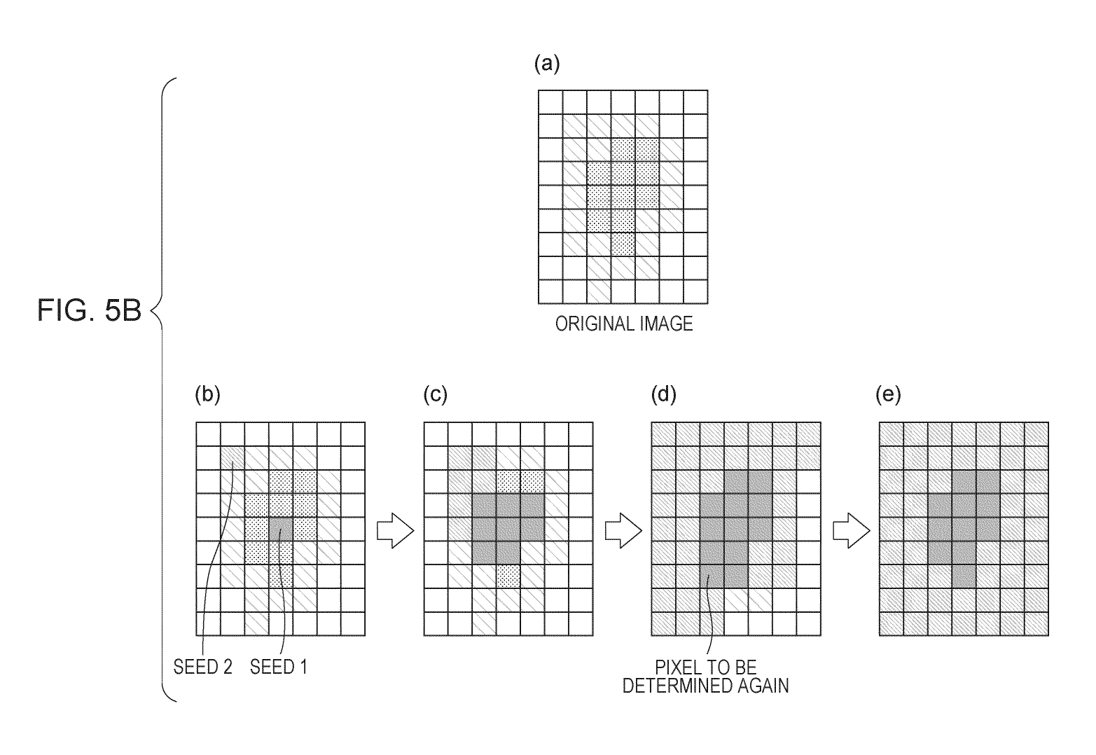

This theorem is as follows. As shown in FIG. 5A, a virtual node of the foreground is set as a start point (source), and a virtual node of the background is set as an end point (sink). Then, the start point is linked to representative positions of a foreground region specified by a user, and representative positions of a background region specified by the user are linked to the end point. Then, assuming that water flows from the start point, the maximum amount of water flowing from the start point to the end point is calculated. Assuming that the value of a link from the foreground to the start point indicates a thickness of a water pipe, the total value of a cut constituted by portions causing a bottleneck (water is difficult to flow) is the maximum amount of water. That is, by cutting the links causing a bottleneck, the foreground and the background can be separated (graph cut).

A specified region may be cut by a region growing technique after a seed is provided.

FIG. 5B illustrates a specific example in which an image is segmented into two regions when two seeds are provided.

In this example, a seed 1 and a seed 2 are provided, as indicated by part (b) of FIG. 5B, to an original image shown in part (a) of FIG. 5B. Then, the two regions grow on the basis of the seed 1 and the seed 2 as base points. In this case, each region may grow according to the proximity of pixel values of adjacent pixels in the original image. If there is a conflict between the two regions, as indicated by part (c) of FIG. 5B, an undetermined pixel may be determined again concerning to which region the pixel belongs, on the basis of the relationship between the pixel value of the subject pixel and that of an adjacent pixel. In this case, the technique disclosed in the following document may be employed.

V. Vezhnevets and V. Konouchine: “Grow-Cut”—Interactive Multi-label N-D Image Segmentation By Cellular Automata”, Proc. Graphicon. pp 150-156 (2005)

As indicated by part (d) of FIG. 5B, the subject pixel is ultimately determined to be the region of the seed 2. The original image is segmented into two regions on the basis of the two seeds, as indicated by part (e) of FIG. 5B.

The above-described examples refer to segmentation of image regions, and specific examples of the technique for cutting an image region by utilizing the region growing technique and a graph have been discussed. In this exemplary embodiment, however, the technique for cutting an image region is not particularly restricted, and any technique may be applicable.

The specified region detector 14 then adds a flag (for example, 1 or 255) representing a specified region to pixels forming a specified image which is cut as described above, and adds a flag (for example, 0) representing an unspecified region to pixels forming an unspecified region, and outputs the resulting image.

With the use of the approach to cutting a specified region user-interactively, the precision in cutting a specified region is enhanced.

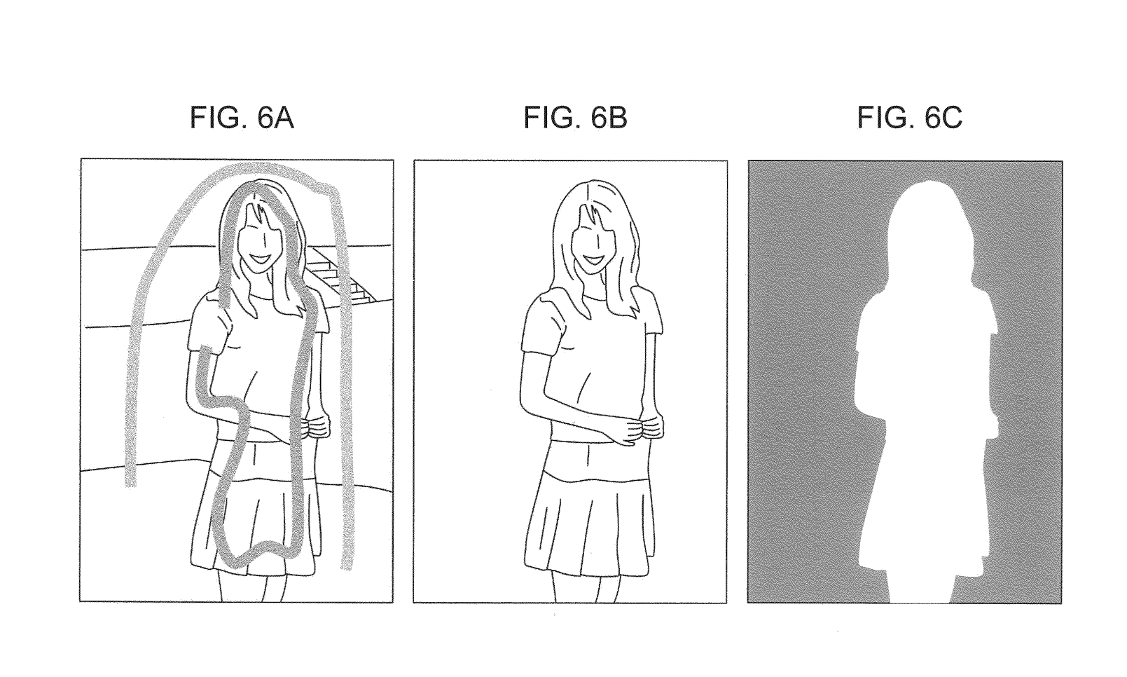

FIGS. 6A through 6C illustrate a specified region cut from an image shown in FIG. 4.

FIG. 6A illustrates an original image from which a specified region has not yet been cut. FIG. 6B illustrates a specified region cut from the original image. FIG. 6B shows that only a person in the foreground is cut from the original image.

FIG. 6C illustrates the distribution of the values of flags added to individual pixels of the image shown in FIG. 4. A white portion is a specified region to which the value 1 is added. A black portion is an unspecified region to which the value 0 is added. The image shown in FIG. 6C may also be regarded as a mask for segmenting the original image into a specified region and an unspecified region.

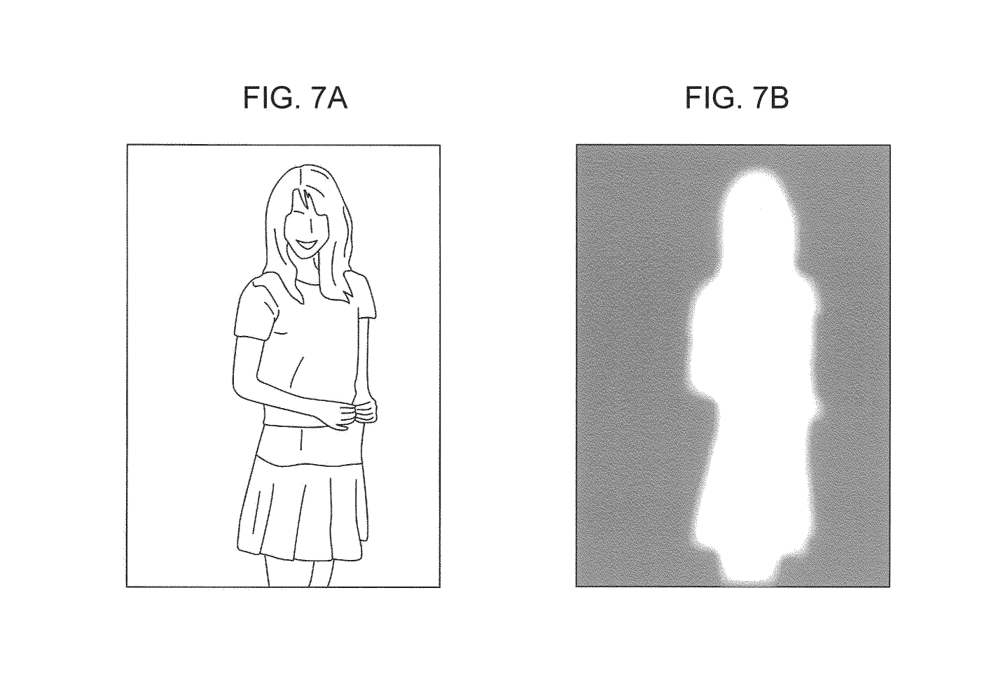

FIGS. 7A and 7B illustrate a specified region as a result of performing processing for blurring the boundary between a specified region and an unspecified region.

FIG. 7A illustrates a cut specified region. FIG. 7B illustrates the distribution of the values of a mask used for segmentation of an original image. The distribution shown in FIG. 7B is different from that shown in FIG. 6C in that, instead of fixing the specified region to the value 1 and the unspecified region to the value 0, the value in a range from 0 to 1 is added to both of the specified region and the unspecified region. The value of a mask is normally 1 in a specified region and 0 in an unspecified region. In this case, however, the value from 0 to 1 is added to an area around the boundary between the specified region and the unspecified region. That is, the mask shown in FIG. 7B is a smoothing mask that makes the boundary between the specified region and the unspecified region blur.

In order to cut a specified region by using this smoothing mask, an image obtained by convoluting a pixel value w(x, y) of each pixel of the image shown in FIG. 4 (x and y denote a position of a pixel in the image) by a Gaussian function expressed by equation (2) is output.

$$G ( x , y ) = \frac{1}{2 π {σ}^{2}} {e}^{- \frac{{x}^{2} + {y}^{2}}{2 {σ}^{2}}} \qquad ( 2 )$$

In equation (2), σ is a parameter representing the degree of blurring. To convolute the pixel value w(x, y) by using equation (2), equation (3) is used.

w_{G}(x,y)=G(x,y)\textcircled{×}w(x,y) (3)

By using W_{G}(x, y) in equation (3), the boundary between a specified region and a unspecified region is smoothed, thereby making it possible to cut a specified region having a blurred boundary. Although in this example a smoothing mask is generated by using a Gaussian function, the moving average method may be used.

By blurring an area around the boundary, it is possible to cut a specified region that has a small step difference at the boundary and thus looks more natural.

In the example shown in FIG. 4, the foreground is separated from the background and is set as the specified region. However, segmentation of an image is not restricted to this example.

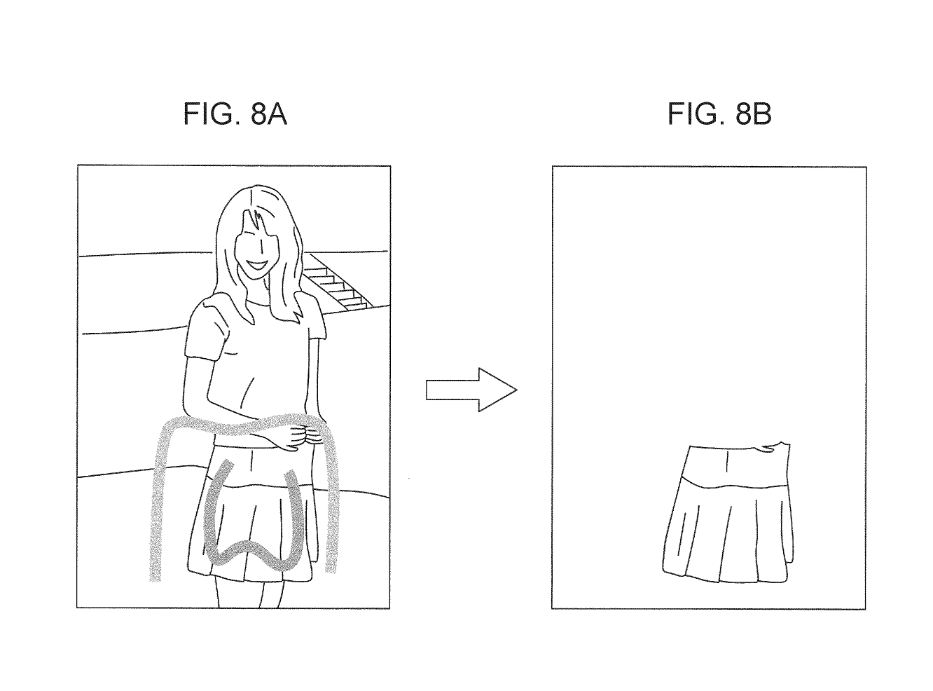

FIGS. 8A and 8B illustrate a second example of the approach to selecting a specified region user-interactively.

In this example, as a specified region, a skirt is cut from the person's clothes in the image displayed on the display device 20.

In this case, in a manner similar to the example shown in FIG. 4, a user provides a path of a specified region and a path of an unspecified region, as representatives of the specified region and the unspecified region, with a boundary between the two paths.

More specifically, as shown in FIG. 8A, the user draws a path of the skirt and a path of a region outside the skirt by using the input device 30. As a result, the skirt portion may be cut as a specified region. A description will be given below, assuming that the skirt portion is a specified region.

Referring back to FIG. 2, the determining unit 15 determines whether or not the detected specified region is an image having a low saturation. For example, the determining unit 15 determines that the specified region is an image having a low saturation if the saturation (S) of the specified region is equal to or smaller than a predetermined threshold. More specifically, for example, if, among all pixels forming the specified region, the saturation (S) of pixels equal to or greater than a first threshold is equal to or smaller than a second threshold, the determining unit 15 determines that the specified region is an image having a low saturation. Alternatively, if the average value of the saturation (S) of all pixels forming the specified region is equal to or smaller than a third threshold, the determining unit 15 may determine that the specified region is an image having a low saturation.

In this exemplary embodiment, it is assumed that the color of the image of the skirt which is set as the specified region is close to gray and that the specified region is thus an image having a low saturation. Accordingly, the determining unit 15 determines that the specified region is an image having a low saturation.

If the detected specified region is an image having a low saturation which is lower than a predetermined saturation, the hue replacement unit 16 changes image information in this specified region so that hue (H) values will become uniform.

That is, if the image has a low saturation color closer to gray, as stated above, the hue (H) values are distributed almost over the entire specified region, and if the saturation (S) is enhanced in this state, the specified region turns out to have various colors, thereby making image adjustment nonuniform.

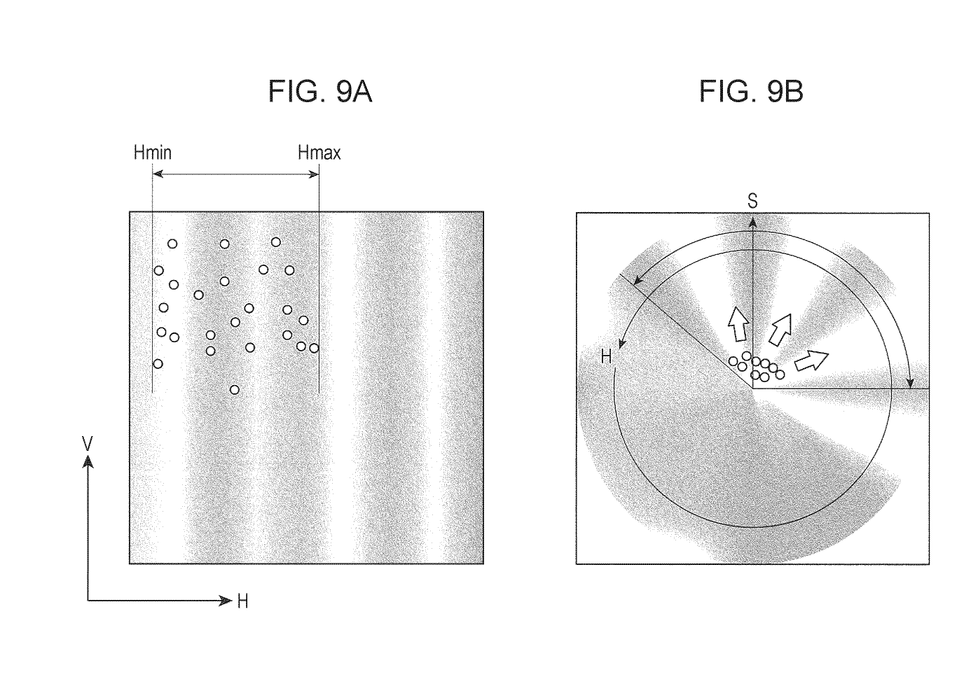

FIGS. 9A and 9B illustrate the distribution of hue (H) values when an image has a color of a low saturation close to gray.

FIG. 9A illustrates the distribution of pixel values in an H-V plane. FIG. 9B illustrates the distribution of pixel values in an H-S plane. Both of FIGS. 9A and 9B show that the hue (H) values are distributed in a wide area within a range defined by double-headed arrows.

In this state, if the saturation (S) is enhanced, as indicated by the thick arrows in FIG. 9B, various colors unique to pixels are visualized, so that a resulting image turns out to have nonuniform colors. If an image is a low saturation image close to gray, a user does not recognize that this image has various hue (H) values in the original image that has not been subjected to image processing. However, if the user enhances the saturation of the image, the above-described phenomenon appears.

Thus, in this exemplary embodiment, if a specified region is a low saturation image, the hue replacement unit 16 changes image information representing this specified region so that hue (H) values will become uniform.

This will be explained below more specifically. The hue replacement unit 16 first calculates an average hue value Have in a specified region. If a hue value at a position (x, y) of each pixel within the specified region is indicated by H(x, y), the average hue value Have may be calculated by equation (4). In equation (4), N is the number of pixels within a specified region and D is the specified region.

$$Have = \frac{1}{N} {\sum }_{D} H ( x , y ) \qquad ( 4 )$$

The hue replacement unit 16 replaces a hue value H (x, y) by this average hue value Have. In this case, the saturation S(x, y) and the value V(x, y) are not changed. This replacement processing may be represented by expressions (5). Then, Have, S(x, y), and V(x, y) after this replacement processing represent image information obtained as a result of replacing the hue values so that hue (H) values will become uniform.

H(x,y)→Have

S(x,y)→S(x,y)

V(x,y)→V(x,y) (5)

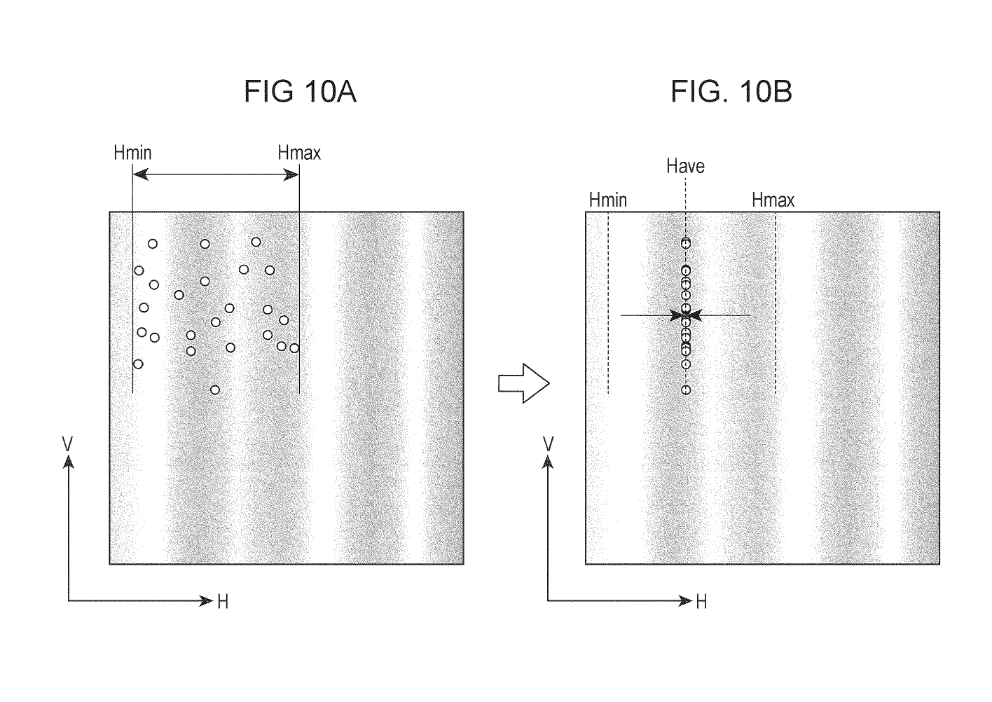

FIGS. 10A and 10B illustrate the replacement of hue values by using expressions (5). FIG. 10A is similar to FIG. 9A, and illustrates the distribution of hue values H(x, y) in the H-V plane which have not been replaced. FIG. 10B illustrates the distribution of hue values H(x, y) in the H-V plane which have been replaced. FIG. 10B shows that the hue values are replaced by the average hue value Have.

Alternatively, instead of uniformly replacing the hue values H(x, y) by the average hue value Have, the hue values H(x, y) may be replaced so that they will approximate to the average hue value Have. In this case, too, the saturation S(x, y) and the value V(x, y) are not changed. This replacement processing may be represented by expressions (6). In expressions (6), Haveₜ(x, y) is a value close to the average hue value Have. Then, Haveₜ(x, y), S(x, y), and V(x, y) after this replacement processing represent image information obtained as a result of replacing the hue values so that hue (H) values will become substantially uniform.

H(x,y)→Haveₜ(x,y)

S(x,y)→S(x,y)

V(x,y)→V(x,y) (6)

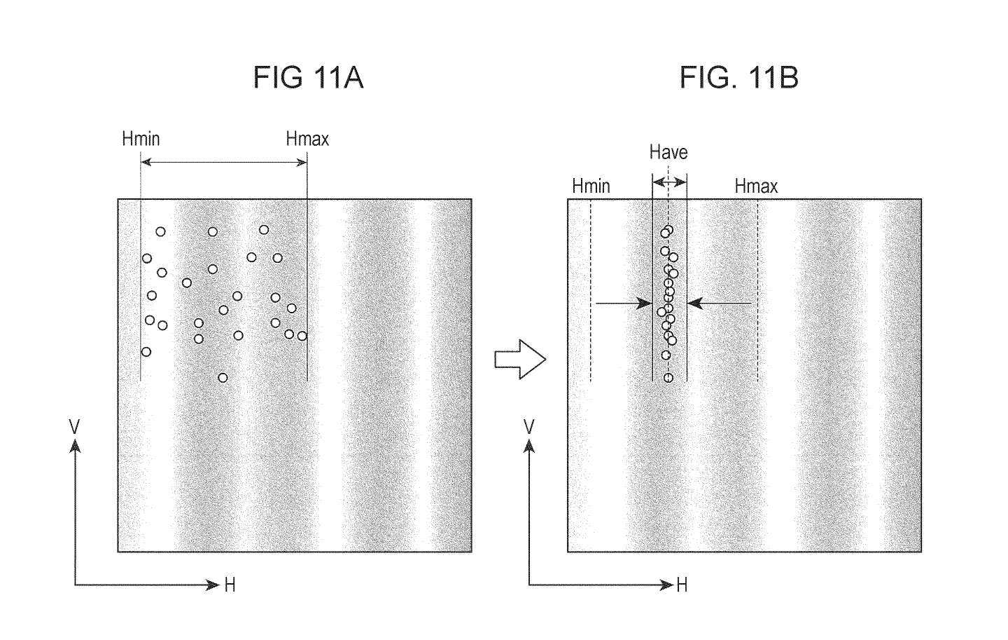

FIGS. 11A and 11B illustrate the replacement of hue values H(x, y) so that they will approximate to the average hue value Have. FIG. 11A is similar to FIG. 9A, and illustrates the distribution of hue values H(x, y) in the H-V plane which have not been replaced. FIG. 11B illustrates the distribution of hue values H(x, y) in the H-V plane which have been replaced. FIG. 11B shows that the hue values H(x, y) are replaced so that they will approximate to the average hue value Have, since they are distributed within a narrow range defined by the double-headed arrow around the average hue value Have.

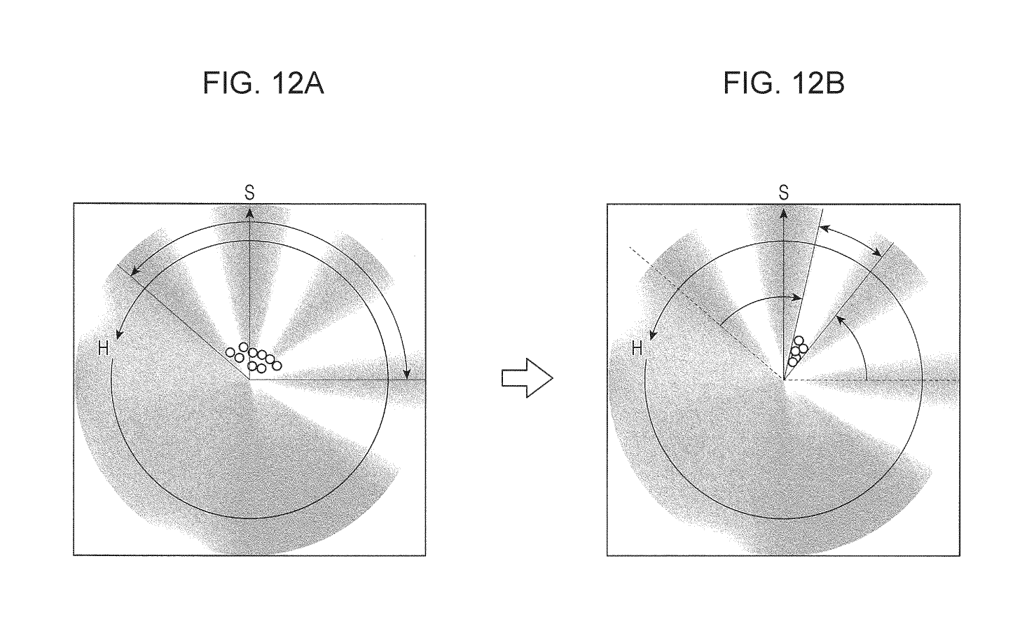

FIG. 12A is similar to FIG. 9B, and illustrates the distribution of hue values H(x, y) in the H-S plane which have not been replaced. FIG. 12B illustrates the distribution of the hue values H(x, y) in the H-S plane which have been replaced by using the technique discussed in FIGS. 10A and 10B or FIGS. 11A and 11B. FIG. 12B shows that the hue values are replaced so that they will be distributed in a narrower range defined by the double-headed arrow.

In the above-described examples, by using the average hue value Have as a reference value, the hue values H(x, y) are replaced by this average hue value Have, or are replaced so that they will approximate to this average hue value Have. However, the replacement technique for the hue values H(x, y) is not restricted to these examples. For example, any one of the hue values within a range shown in FIG. 9A in which the hue values are distributed may be used as a reference value, and the hue values H(x, y) may be replaced by this reference value, or may be replaced so that they will approximate to this reference value. Alternatively, any one of hue values outside a range in which the hue values are distributed may be used as a reference value, and the hue values H(x, y) may be replaced by this reference value, or may be replaced so that they will approximate to this reference value. That is, any hue value may be used as a reference value as long as the uniformity of the hue (H) is substantially maintained.

The image processor 17 performs image processing on the specified region on the basis of replaced image information and an instruction from a user.

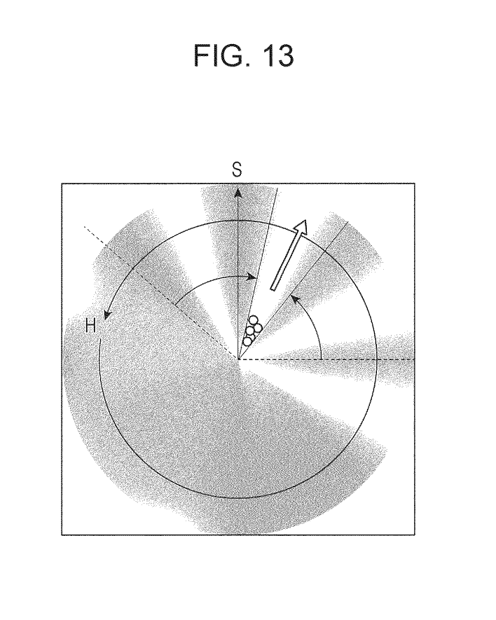

FIG. 13 illustrates the distribution of pixel values in the H-S plane as a result of enhancing saturation (S) on the basis of the replaced image information obtained by replacing hue values.

Since the hue (H) values are substantially uniform, as shown in FIG. 13, when the saturation (S) is enhanced in this state, the saturation (S) of each pixel is enhanced while the hue (H) values are being substantially consistent, as indicated by the thick arrow, thereby preventing the resulting color from being nonuniform.

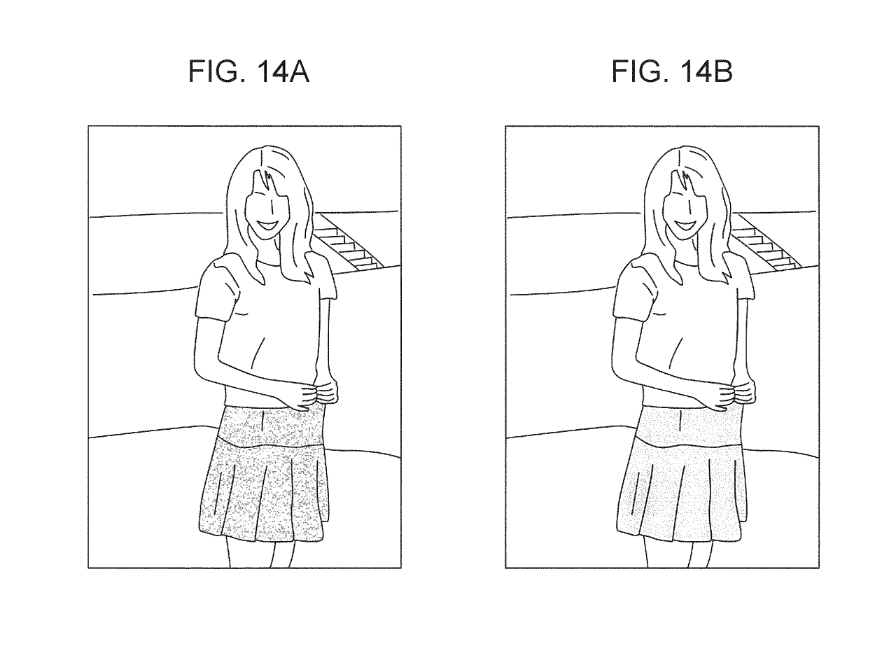

FIG. 14A illustrates an example of an image obtained as a result of enhancing the saturation (S) without making the hue (H) values of a skirt portion, which is set as a specified region, uniform. FIG. 14B illustrates an example of an image obtained as a result of enhancing the saturation (S) after making the hue (H) values of the skirt portion, which is set as a specified region, uniform.

FIG. 14A shows that, if the saturation (S) is enhanced without making the hue (H) values uniform, the color of the skirt portion, which is set as a specified region, becomes nonuniform.

In contrast, FIG. 14B shows that, if the saturation (S) is enhanced after making the hue (H) values uniform, the color of the skirt portion, which is set as a specified region, has a solid hue (H), for example, green. After coloring is performed on the image by enhancing the saturation (S), the hue (H) and the value (V) may also be adjusted as desired. Adjustment of the hue (H), saturation (S), and value (V) may be performed in any order.

It is assumed that image processing is performed by using, for example, Haveₜ(x, y), S(x, y), and V(x, y) as replaced image information and that adjusted image information as a result of performing image processing is indicated by H′(x, y), S′(x, y), and V′(x, y). In this case, this image processing is represented by expressions (7).

Haveₜ(x,y)→H′(x,y)

S(x,y)→S′(x,y)

V(x,y)→V′(x,y) (7)

In this case, the user inputs user instruction information indicating an instruction concerning an element and amount of image processing to be performed into the image processor 17. The user instruction information may be input into the image processor 17 as a result of the user sliding sliders displayed on the display device 20 by using the input device 30.

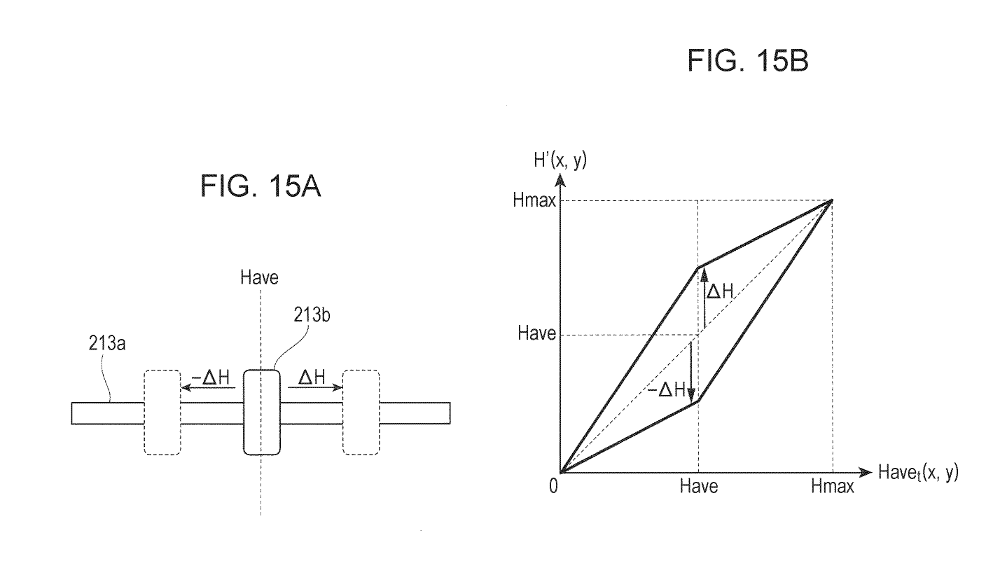

FIG. 15A illustrates an example of a slider for adjusting the hue (H).

A slide bar 213a and a slider 213b are shown in FIG. 15A. The slider 213b is slidable on the slide bar 213a to the right and left sides in FIG. 15A as a result of a user operating the input device 30. In the initial state, the slider 213b is positioned at the center of the slide bar 213a, and the value of the hue (H) that has not been adjusted is indicated. If the user slides the slider 213b to the right side in FIG. 15A from the position corresponding to the center of the slide bar 213a, the hue (H) is increased. The amount by which the hue (H) is increased is indicated by ΔH in FIG. 15A. In contrast, if the user slides the slider 213b to the left side in FIG. 15A from the position corresponding to the center of the slide bar 213a, the hue (H) is decreased. The amount by which the hue (H) is decreased is indicated by −ΔH in FIG. 15A.

As discussed with reference to FIGS. 10A and 10B, if the hue (H) is uniformly replaced by the average hue value Have, the adjusted hue H′(x, y) is expressed by equation (8).

H′(x,y)=Have+ΔH (8)

As discussed with reference to FIGS. 11A and 11B, if the hue (H) values are replaced so that they will approximate to the average hue value Have, the adjusted hue H′(x, y) is expressed as follows.

FIG. 15B illustrates an example of a tone curve used for adjusting the hue (H) by using the slider shown in FIG. 15A when the hue (H) values are replaced so that they will approximate to the average hue value Have. The horizontal axis indicates the hue Haveₜ(x, y) that has not been adjusted, and the vertical axis indicates the hue H′(x, y) that has been adjusted.

In FIG. 15B, ΔH indicates an amount by which the hue (H) is increased from the average hue value Have, and −ΔH indicates an amount by which the hue (H) is decreased from the average hue value Have.

That is, when the hue (H) is increased by ΔH, the average hue value Have increases by ΔH, and thus, the adjusted hue (H) is expressed by Have+ΔH. The tone curve of the hue H′(x, y) is indicated by the upper thick lines in FIG. 15B constituted by a line connecting the position at Have+ΔH and the minimum value 0 of the hue (H) and a line connecting the position at Have+ΔH and the maximum value Hmax of the hue (H).

On the other hand, when the hue (H) is decreased by ΔH, the average hue value Have decreases by ΔH, and thus, the adjusted hue (H) is expressed by Have−ΔH. The tone curve of hue H′(x, y) is indicated by the lower thick lines in FIG. 15B constituted by a line connecting the position at Have−ΔH and the minimum value 0 of the hue (H) and a line connecting the position at Have−ΔH and the maximum value Hmax of the hue (H).

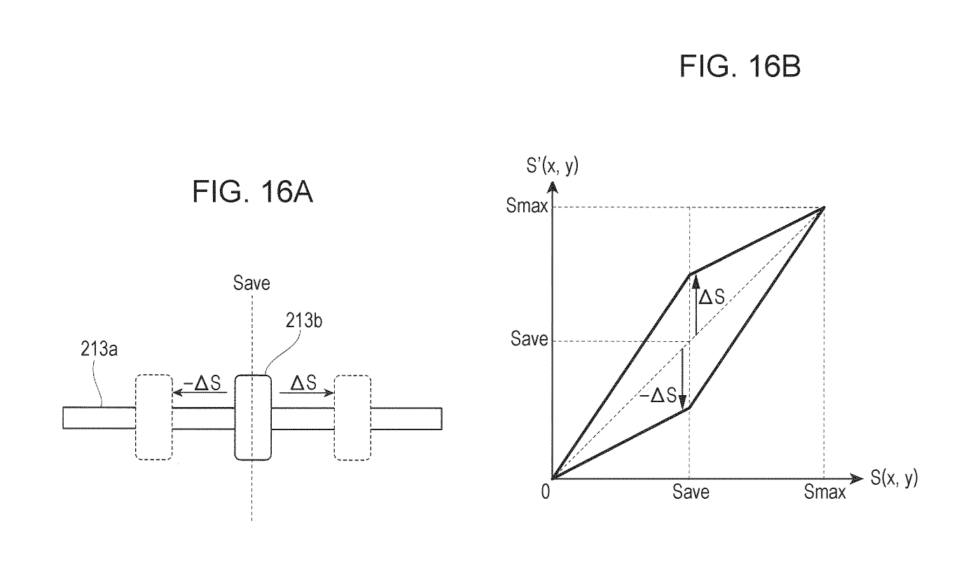

FIG. 16A illustrates an example of a slider for adjusting the saturation (S). The saturation (S) may be adjusted in a manner similar to the hue (H), as shown in FIG. 15A. In the initial state, the slider 213b is positioned at the center of the slide bar 213a, and the value S(x, y) of the saturation (S) that has not been adjusted is indicated. If the user slides the slider 213b to the right side in FIG. 16A from the position corresponding to the center of the slide bar 213a, the saturation (S) is increased. In contrast, if the user slides the slider 213b to the left side in FIG. 16A from the position corresponding to the center of the slide bar 213a, the saturation (S) is decreased. The amount by which the saturation (S) is increased is indicated by ΔS and the amount by which the saturation (S) is decreased is indicated by −ΔS in FIG. 16A.

FIG. 16B illustrates an example of a tone curve used for adjusting the saturation (S) by using the slider shown in FIG. 16A. The horizontal axis indicates the saturation S(x, y) that has not been adjusted, and the vertical axis indicates the saturation S′(x, y) that has been adjusted.

In FIG. 16B, ΔS indicates an amount by which the saturation (S) is increased from the average saturation value Save, and −ΔS indicates an amount by which the saturation (S) is decreased from the average saturation value Save.

When the saturation (S) is increased by ΔS, the average saturation value Save increases by ΔS, and thus, the adjusted saturation (S) is expressed by Save+ΔS. The tone curve of the saturation S′(x, y) is indicated by the upper thick lines in FIG. 16B constituted by a line connecting the position at Save+ΔS and the minimum value 0 of the saturation (S) and a line connecting the position at Save+ΔS and the maximum value Smax of the saturation (S).

On the other hand, when the saturation (S) is decreased by ΔS, the average saturation value Save decreases by ΔS, and thus, the adjusted saturation (S) is expressed by Save−ΔS. The tone curve of the saturation S′(x, y) is indicated by the lower thick lines in FIG. 16B constituted by a line connecting the position at Save−ΔS and the minimum value 0 of the saturation (S) and a line connecting the position at Save−ΔS and the maximum value Smax of the saturation (S).

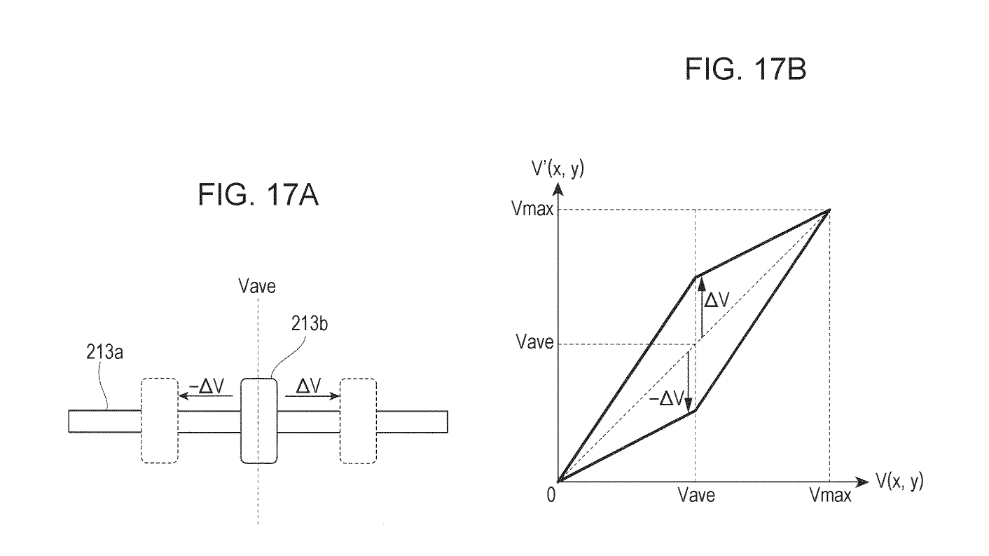

FIG. 17A illustrates an example of a slider for adjusting the value (V). The value (V) may be adjusted in a manner similar to the hue (H), as shown in FIG. 15A. In the initial state, the slider 213b is positioned at the center of the slide bar 213a, and the value V(x, y) that has not been adjusted is indicated. If the user slides the slider 213b to the right side in FIG. 17A from the position corresponding to the center of the slide bar 213a, the value (V) is increased. In contrast, if the user slides the slider 213b to the left side in FIG. 17A from the position corresponding to the center of the slide bar 213a, the value (V) is decreased. The amount by which the value (V) is increased is indicated by ΔV and the amount by which the value (V) is decreased is indicated by −ΔV in FIG. 17A.

FIG. 17B illustrates an example of a tone curve used for adjusting the value (V) by using the slider shown in FIG. 17A. The horizontal axis indicates the value V(x, y) that has not been adjusted, and the vertical axis indicates the value V′(x, y) that has been adjusted.

In FIG. 17B, ΔV indicates an amount by which the value (V) is increased from the average value Vave, and −ΔV indicates an amount by which the value (V) is decreased from the average value Vave.

When the value (V) is increased by ΔV, the average value Vave increases by ΔV, and thus, the adjusted value (V) is expressed by Vave+ΔV. The tone curve of the value V′(x, y) is indicated by the upper thick lines in FIG. 17B constituted by a line connecting the position at Vave+ΔV and the minimum value 0 of the value (V) and a line connecting the position at Vave+ΔV and the maximum value Vmax of the value (V).

On the other hand, when the value (V) is decreased by ΔV, the average value Vave decreases by ΔV, and thus, the adjusted value (V) is expressed by Vave−ΔV. The tone curve of the value V′(x, y) is indicated by the lower thick lines in FIG. 17B constituted by a line connecting the position at Vave−ΔV and the minimum value 0 of the value (V) and a line connecting the position at Vave−ΔV and the maximum value Vmax of the value (V).

User instruction information does not have to be input by using a slider. User instruction information may be input, for example, by using the following method.

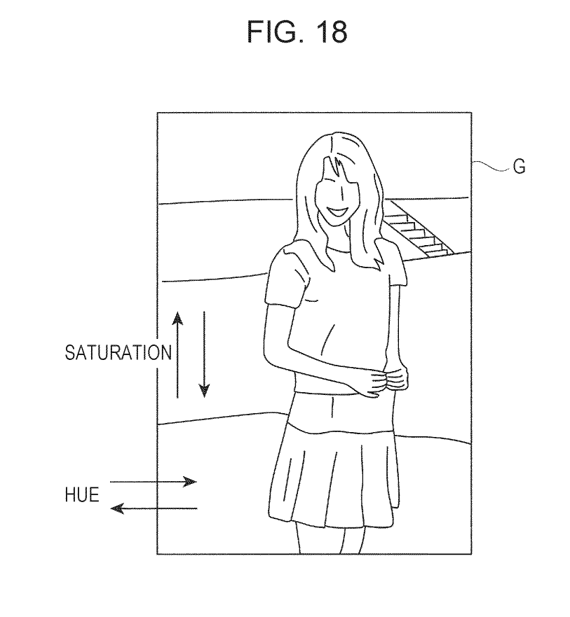

FIG. 18 illustrates an example of a frame displayed on the display screen 21 when adjustment of the hue (H) and the saturation (S) is performed.

In the example shown in FIG. 18, a user adjusts the hue (H) and the saturation (S) after selecting a specified region. In this case, the user operates the input device 30 and moves a cursor displayed on the display screen 21 vertically and horizontally to perform a drag operation. If the display screen 21 is a touch panel, the user moves a finger or a touch pen vertically and horizontally to swipe the display screen 21.

When the user performs a drag operation or a swipe operation horizontally, the hue (H) is adjusted. That is, when the user performs a drag operation or a swipe operation in the right direction, the hue (H) of a specified region is increased. When the user performs a drag operation or a swipe operation in the left direction, the hue (H) of a specified region is decreased.

When the user performs a drag operation or a swipe operation vertically, the saturation (S) is adjusted. That is, when the user performs a drag operation or a swipe operation in the upward direction, the saturation (S) of a specified region is increased. When the user performs a drag operation or a swipe operation in the downward direction, the saturation (S) of a specified region is decreased.

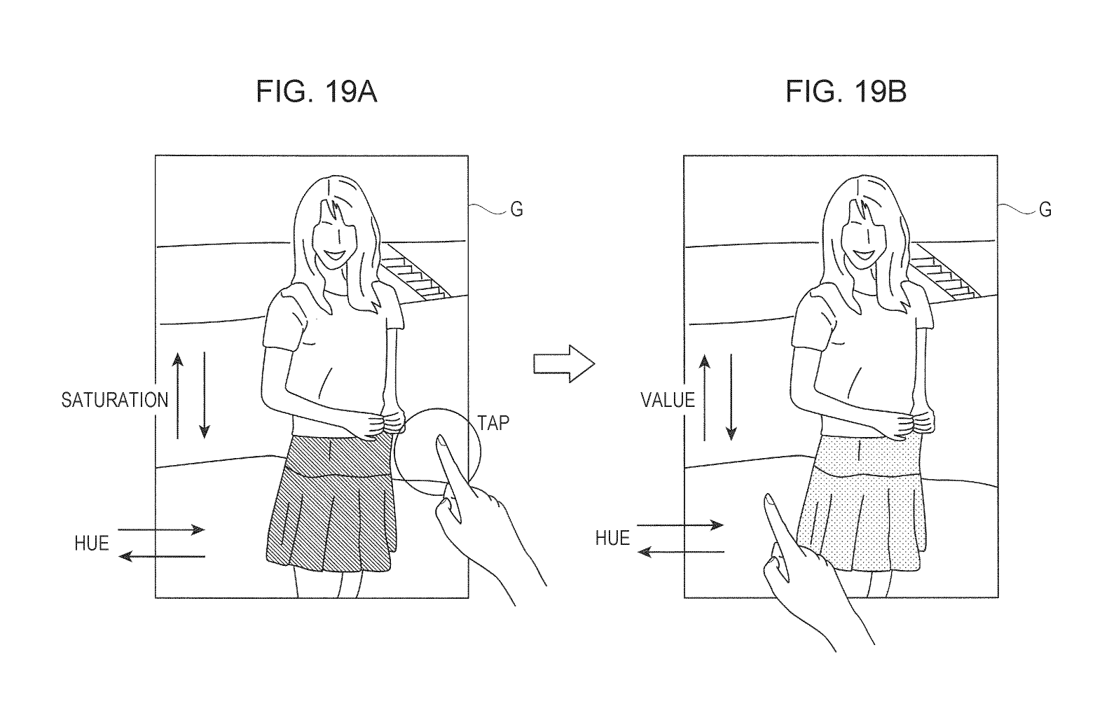

FIGS. 19A and 19B illustrate another example of frames displayed on the display screen 21 when adjustment of the hue (H), the saturation (S), and the value (V) is performed.

In the example shown in FIG. 19A, the user switches elements to be adjusted by performing a tap operation. That is, if the input device 30 is a touch panel, when the user taps a certain portion of the display screen 21, elements to be adjusted are switched from the hue and the saturation to the hue and the value, and vice versa.

It is assumed that elements to be adjusted have been switched from the hue and the saturation shown in FIG. 19A to the hue and the value shown in FIG. 19B. In this case, as shown in FIG. 19B, when the user performs a swipe operation horizontally, the hue (H) is adjusted, and when the user performs a swipe operation vertically, the value (V) is adjusted. In this case, adjustment of the hue (H) is performed in a manner similar to the operation shown in FIG. 18. When the user performs a swipe operation in the upward direction, the value (V) of a specified region is increased. When the user performs a swipe operation in the downward direction, the value (V) of a specified region is decreased. The amount by which the hue (H) or the value (V) is adjusted may be changed by a distance by which a finger or a touch pen is moved or the number of times a finger or a touch pen is moved, in a manner similar to the operation discussed with reference to FIG. 18.

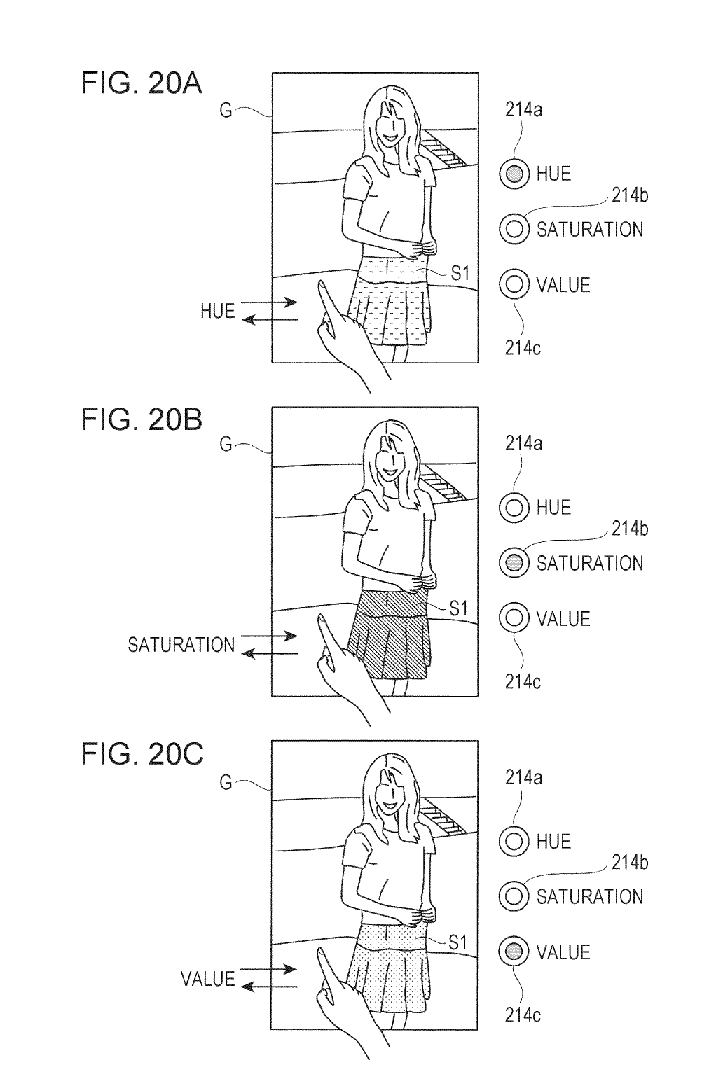

FIGS. 20A through 20C illustrate still another example of frames displayed on the display screen 21 when adjustment of the hue (H), the saturation (S), and the value (V) is performed.

In FIGS. 20A through 20C, an image G including a specified region S1 which has been selected is displayed at the left side of the display screen 21, and on the right side of the display screen 21, radio buttons 214a, 214b, and 214c corresponding to the hue, the saturation, and the value, respectively, are displayed. As the specified region, the specified region S1, which is a skirt portion, is selected. Then, when the user sequentially selects the radio buttons 214a, 214b, and 214c by using the input device 30, the hue, the saturation, and the value are switched as an element to be adjusted.

FIG. 20A illustrates a state in which the hue corresponding to the radio button 214a is being selected.

In this case, if the user moves a cursor or a finger horizontally, as stated above, the hue (H) is adjusted. That is, when the user performs a drag operation or a swipe operation in the right direction, the hue (H) of a specified region is increased. When the user performs a drag operation or a swipe operation in the left direction, the hue (H) of a specified region is decreased.

FIG. 20B illustrates a state in which the saturation corresponding to the radio button 214b is being selected. In this case, if the user moves a cursor or a finger horizontally, as stated above, the saturation (S) is adjusted in a manner similar to the adjustment of the hue (H).

FIG. 20C illustrates a state in which the value corresponding to the radio button 214c is being selected. In this case, if the user moves a cursor or a finger horizontally, as stated above, the value (V) is adjusted in a manner similar to the adjustment of the hue (H).

Referring back to FIG. 2, the image information output unit 18 re-converts image information subjected to image processing as described above from HSV data into RGB data, and then outputs the RGB data. The image information subjected to image processing is supplied to the display device 20. Then, on the basis of this image information, an image is displayed on the display device 20.

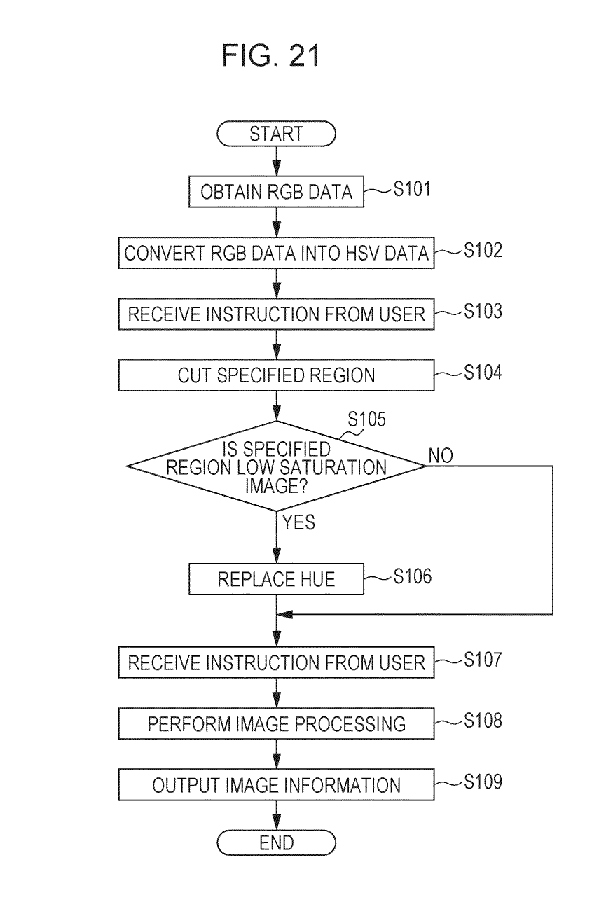

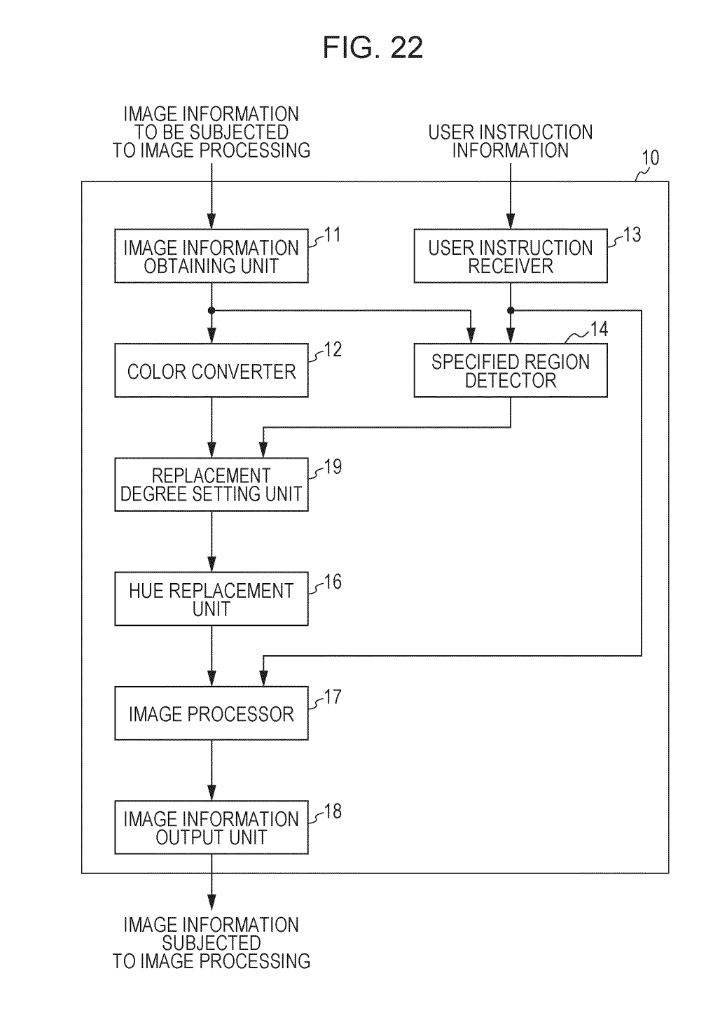

FIG. 21 is a flowchart illustrating an operation performed by the image processing apparatus 10 according to the first exemplary embodiment.

The operation of the image processing apparatus 10 will be discussed below with reference to FIGS. 2 and 21.

In step S101, the image information obtaining unit 11 obtains RGB data as image information representing an image to be subjected to image processing. This RGB data is supplied to the display device 20 and the image that has not been subjected to image processing is displayed on the display device 20.

Then, in step S102, the color converter 12 converts the RGB data into HSV data, which is device-independent color data.

Then, in step S103, by using, for example, the method discussed with reference to FIGS. 8A and 8B, the user specifies an image region to be subjected to image processing by inputting, for example, a path, by using the input device 30. An instruction concerning an image region provided by the user is received by the user instruction receiver 13.

Then, in step S104, the specified region detector 14 performs processing for cutting the specified region by using, for example, the method discussed with reference to FIG. 5A or 5B.

The determining unit 15 then determines in step S105 whether or not the specified region is a low saturation image.

If it is determined that the specified region is a low saturation image (YES in step S105), the process proceeds to step S106. In step S106, the hue replacement unit 16 performs processing for replacing image information representing the specified region so that the hue (H) values will become uniform, by using, for example, one of the methods shown in FIGS. 9A through 12B.

If it is determined that the specified region is not a low saturation image (NO in step S105), the process proceeds to step S107.

In step S107, the user inputs an instruction concerning image processing to be performed on the specified region by using the input device 30. In this case, the user may input an instruction by using sliders discussed with reference to FIGS. 15A through 17B. An instruction input by the user is received by the user instruction receiver 13.

Then, in step S108, the image processor 18 performs image processing on the specified region in response to an instruction from the user. The image processing performed by the image processor 18 is, for example, processing for enhancing the saturation (S), as discussed with reference to FIG. 13.

Then, in step S109, the image information output unit 18 re-converts image information subjected to image processing from HSV data into RGB data, and outputs the RGB data. This RGB data is supplied to the display device 20, and an image subjected to image processing is displayed on the display screen 21.

### Second Exemplary Embodiment

A second exemplary embodiment of the image processing apparatus 10 will now be described below.

FIG. 22 is a block diagram illustrating an example of the functional configuration of the image processing apparatus 10 according to the second exemplary embodiment. Among various functions of the image processing apparatus 10, functions related to the second exemplary embodiment are selected and shown in FIG. 22.

The image processing apparatus 10 of the second exemplary embodiment includes, as shown in FIG. 22, an image information obtaining unit 11, a color converter 12, a user instruction receiver 13, a specified region detector 14, a replacement degree setting unit 19, a hue replacement unit 16, an image processor 17, and an image information output unit 18.

As shown in FIG. 22, the image processing apparatus 10 of the second exemplary embodiment differs from that of the first exemplary embodiment shown in FIG. 2 in that the replacement degree setting unit 19 is disposed, instead of the determining unit 15.

The configurations of the image information obtaining unit 11, the color converter 12, the user instruction receiver 13, the specified region detector 14, the image processor 17, and the image information output unit 18 are similar to those of the counterparts of the first exemplary embodiment. Accordingly, a description will be given below of the replacement degree setting unit 19 and the hue replacement unit 16.

The replacement degree setting unit 19 sets a weight used in the hue replacement unit 16 to change the degree of the uniformity of the hue in accordance with the saturation.

This weight may be determined by setting a weight function representing the degree of the uniformity of the hue in relation to the saturation. In this exemplary embodiment, this weight function will be referred to as a “saturation adaptive function”.

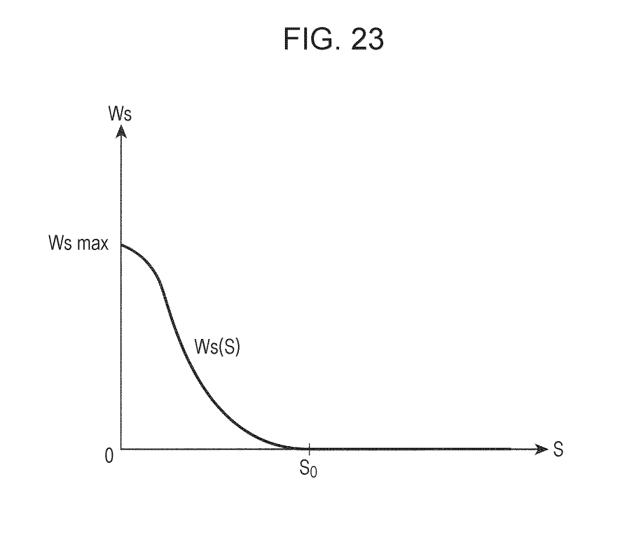

FIG. 23 illustrates an example of the saturation adaptive function.

In FIG. 23, the horizontal axis indicates the saturation (S), and the vertical axis indicates the weight Ws. As shown in FIG. 23, the saturation adaptive function Ws(S) takes the maximum value Wsmax when the saturation (S) is 0, and the saturation adaptive function Ws decreases as the saturation (S) increases and it is reduced to 0 at a predetermined saturation S₀.

Then, the hue replacement unit 16 performs replacement of the hue (H) on the basis of this saturation adaptive function Ws(S). This replacement is performed on the basis of the weight Ws determined by the saturation adaptive function Ws(S). That is, as the weight Ws is greater, the degree of the uniformity of the hue is set to be greater, and as the weight Ws is smaller, the degree of the uniformity of the hue is set to be smaller. This may also be described such that as the saturation (S) is smaller, the degree of the uniformity of the hue is set to be greater, and as the saturation (S) is greater, the degree of the uniformity of the hue is set to be smaller.

In this case, if pixels forming a specified region have a low saturation, the hue replacement unit 16 replaces the hue (H) values so that they will approximate to the average hue value Have. However, if some pixels forming a specified region have a predetermined saturation (S), the replacement of the hue (H) values of such pixels is not performed, and the hue (H) values are maintained.

If the above-described replacement is applied to the replacement of the hue (H) in expressions (6), expressions (6) may be reduced to equation (9). In equation (9), Have_{w}(x, y) corresponds to Haveₜ(x, y), and represents a color close to the average hue value Have.

Have_{w}(x,y)=wₛ(S(x,y))Haveₜ(x,y)+(1−wₛ(S(x,y)))H(x,y) (9)

In this case, Have_{w}(x, y), S(x, y), and V(x, y) represent replaced image information.

A technique using the saturation adaptive function Ws(S) is effective, for example, in a case in which a specified region includes a gradation of colors. That is, if a specified region includes a gradation, after this specified region is subjected to color adjustment, a resulting image is less likely to look natural by using the technique of the first exemplary embodiment. In contrast, by employing the technique using the saturation adaptive function Ws(S), more natural color adjustment may be performed.

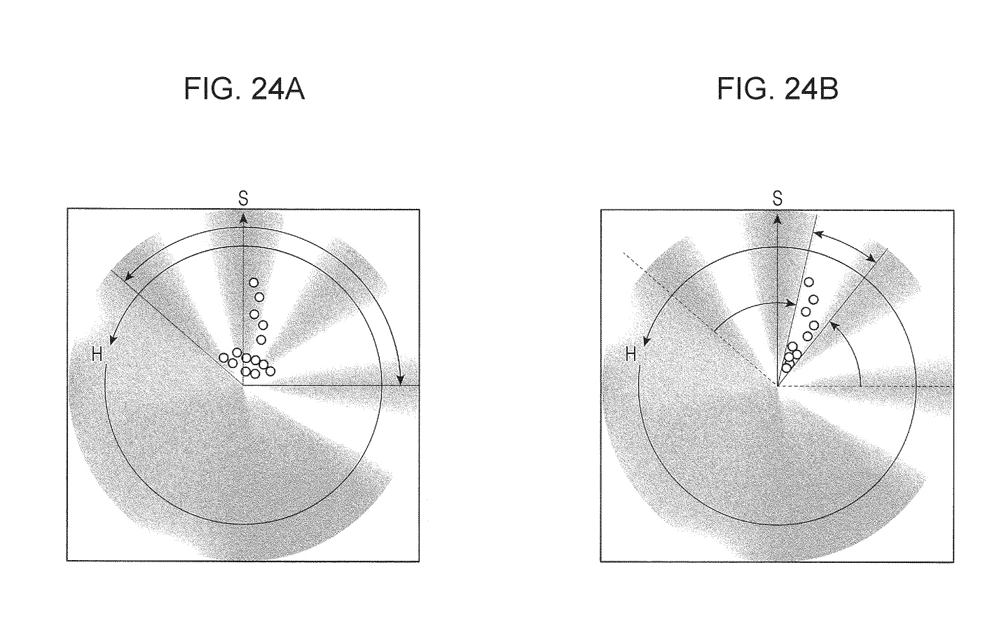

FIG. 24A illustrates the distribution of hue values (H) in the H-S plane when a specified region includes a gradation. In this case, due to the presence of a gradation, some high saturation pixels are also observed in the H-S plane.

FIG. 24B illustrates the distribution of the hue values (H) as a result of replacing the hue values (H) by using the saturation adaptive function Ws(S).

FIG. 24B shows that the hue values (H) of the low saturation pixels are replaced so that they will approximate to the average hue value Have. On the other hand, the hue values (H) of the high saturation pixels are not replaced but are maintained.

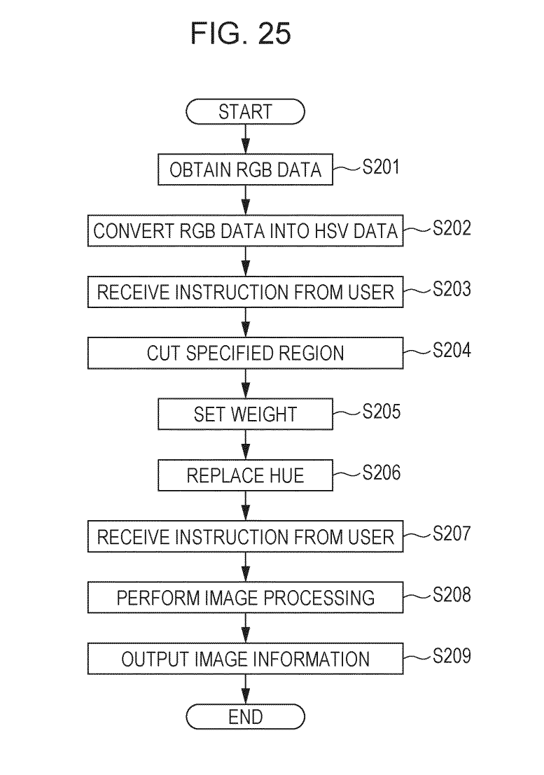

FIG. 25 is a flowchart illustrating an operation performed by the image processing apparatus 10 according to the second exemplary embodiment.

The operation of the image processing apparatus 10 will be discussed below with reference to FIGS. 23 and 25.

In FIG. 25, steps S201 through S204 are respectively similar to steps S101 through S104 of FIG. 21.

In step S205, the replacement degree setting unit 19 sets a weight for changing the degree of the uniformity of the hue in accordance with the saturation. More specifically, the replacement degree setting unit 19 sets a saturation adaptive function, such as that shown in FIG. 23.

Then, in step S206, the hue replacement unit 16 performs processing for replacing image information representing the specified region by using the saturation adaptive function so that the hue (H) values will become substantially uniform.

Steps S207 through S209 are respectively similar to steps S107 through S109 of FIG. 21.

In the first exemplary embodiment, even when a specified region is a low saturation image having a color close to gray, it is possible to decrease the possibility that image adjustment will fail. Additionally, even when a specified region is a low saturation image having a color close to gray, coloring is easily performed.

In the second exemplary embodiment, even when a specified region includes a gradation, it is possible to perform more natural image adjustment.

In the above-described exemplary embodiments, the color converter 12 converts RGB data into HSV data. However, if the image information obtaining unit 11 is able to obtain image information from which hue, saturation, value can be determined, conversion from RGB data into HSV data is not necessary.

### Example of Hardware Configuration of Image Processing Apparatus

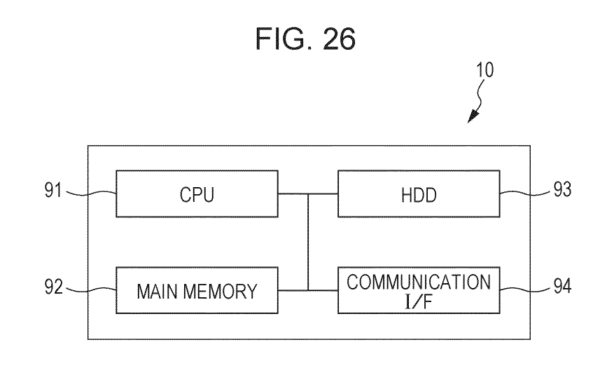

An example of the hardware configuration of the image processing apparatus 10 will be described below with reference to FIG. 26.

The image processing apparatus 10 is implemented by, for example, a PC, as discussed above. The image processing apparatus 10 includes, as shown in FIG. 26, a central processing unit (CPU) 91, which serves as an arithmetic unit, a main memory 92, which serves as a storage unit, and a hard disk drive (HDD) 93. The CPU 91 executes various programs, such as an OS and application software. The main memory 92 is a storage region in which various programs and data used for executing the programs are stored. The HDD 93 is a storage region in which data input into the various programs and data output from the various programs are stored.

The image processing apparatus 10 also includes a communication interface (hereinafter referred to as a “communication I/F”) 94 for performing communication with external devices.

### Description of Program

Processing executed by the image processing apparatus of an exemplary embodiment of the invention may be provided as a program, such as application software.

Accordingly, processing executed by the image processing apparatus 10 may be considered as a program that implements a function of detecting, from an image to be subjected to image processing, a specified region selected by a user as an image region to be subjected to image processing, a function of replacing image information representing the specified region so that hue values in the specified region will become substantially uniform if the specified region is an image exhibiting saturation lower than a predetermined saturation, and a function of performing image processing on the specified region on the basis of the replaced image information.

The program implementing an exemplary embodiment of the invention may be provided by a communication medium. Alternatively, the program may be stored in a recording medium, such as a compact disc-read only memory (CD-ROM), and may be provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a specified region detector that detects, from an image to be subjected to image processing, a specified region selected by a user as an image region to be subjected to image processing;
a hue replacement unit that replaces image information concerning the specified region so that hue values represented by the image information will become substantially uniform if the specified region is an image exhibiting saturation lower than a predetermined saturation; and
an image processor that performs image processing on the specified region on a basis of the image information replaced by the hue replacement unit.

2. The image processing apparatus according to claim 1, further comprising:
a replacement degree setting unit that sets a weight used in the hue replacement unit so as to change a degree of the uniformity of a hue value of a pixel forming the specified region in accordance with a value of saturation of the pixel,
wherein the replacement degree setting unit sets the weight so that the degree of the uniformity of a hue value of a pixel forming the specified region will become greater as a value of saturation of the pixel is smaller and so that the degree of the uniformity of a hue value of a pixel forming the specified region will become smaller as a value of saturation of the pixel is greater.

3. The image processing apparatus according to claim 1, wherein the hue replacement unit replaces the image information on a basis of an average of hue values represented by the image information concerning the specified region.

4. The image processing apparatus according to claim 2, wherein the hue replacement unit replaces the image information on a basis of an average of hue values represented by the image information concerning the specified region.

5. An image processing method comprising:
detecting, from an image to be subjected to image processing, a specified region selected by a user as an image region to be subjected to image processing;
replacing image information concerning the specified region so that hue values represented by the image information will become substantially uniform if the specified region is an image exhibiting saturation lower than a predetermined saturation; and
performing image processing on the specified region on a basis of the replaced image information.

6. An image processing system comprising:
a display device that displays an image;
an image processing apparatus that performs image processing on image information representing an image displayed on the display device; and
an input device through which a user inputs an instruction concerning image processing into the image processing apparatus,
the image processing apparatus including
a specified region detector that detects, from an image to be subjected to image processing, a specified region selected by a user as an image region to be subjected to image processing,
a hue replacement unit that replaces image information concerning the specified region so that hue values represented by the image information will become substantially uniform if the specified region is an image exhibiting saturation lower than a predetermined saturation, and
an image processor that performs image processing on the specified region on a basis of the image information replaced by the hue replacement unit.

7. A non-transitory computer readable medium storing a program causing a computer to execute a process, the process comprising:
detecting, from an image to be subjected to image processing, a specified region selected by a user as an image region to be subjected to image processing;
replacing image information concerning the specified region so that hue values represented by the image information will become substantially uniform if the specified region is an image exhibiting saturation lower than a predetermined saturation; and
performing image processing on the specified region on a basis of the replaced image information.
